(19) United States
(12) Patent Application Publication
(10) Pub. No.: US 2005/0041390 A1
(43) Pub. Date: Feb. 24, 2005

(54) Structure of notebook computer

(75) Inventor: Yu-Fu Huang, Taipei (TW)

Correspondence Address: BACON & THOMAS, PLLC, 625 SLATERS LANE, FOURTH FLOOR, ALEXANDRIA, VA, 22314, US

(73) Assignee: First International Computer, Inc., Taipei (TW)

(21) Appl. No.: 10/644,843

(22) Filed: Aug. 21, 2003

(51) Int. Cl. G06F 1/20

(52) U.S. Cl. 361/687

(57) ABSTRACT

The present invention is to provide a structure of notebook computer comprising a display assembly having a LCD (liquid crystal display) fitted on its front surface, an internal motherboard coupled to the LCD and a computer case having a power supply assembly and an input/output (I/O) interface, wherein the power supply assembly is electrically coupled to the motherboard by means of a power cord for supplying a rated power to the motherboard, and the I/O interface is coupled to the motherboard by means of a data cable, thereby reserving more interior space of the computer case for installing other electronic devices, reducing thickness of the computer case, and making the computer case more expandable.

### FIELD OF THE INVENTIO/N

The present invention relates to structure of notebook computer and more particularly to the structure of such notebook computer with improved characteristics.

### BACKGROUND OF THE INVENTI/ON

The world we are living in has entered into a new era with information prosperously being developed. All kinds of products of high-technology related to computer are commercially available due to the fast progress in information technology. The fast development of the new products not only shortens time required for communication between people in different geographical areas, but also greatly, advantageously influences our daily life and work. Thus, it is impossible of doing without them. In response to all kinds of new information products being developed, especially the wide popularity of notebook computers, most users become more critical with respect to the convenience in using them. Thus, whether the notebook computers produced in the future can provide a more convenient and effective service will be an indicator to decide whether manufacturing technology of the information products owned by one country is more advanced than other countries.

The development trend of information products (e.g., notebook computers) is slimness, compactness, and lightweight in consideration of weight and size. It is understood that the information product market is very competitive. As such, a wide variety of notebook computers are commercially available. This can put a great pressure on the sales of all computer manufacturers. Fortunately, more types of computers means more chances for consumers to choose. It is concluded that if a notebook computer manufacturer wants to win over other competitive manufacturers how to provide users with ergonomic, powerful and all-in-one notebook computers in a reasonable price should be a deciding factor.

Nowadays, there is substantially no significant difference in processing speed between a notebook computer and a desktop computer. Further, users may no more have the impression that a notebook computer is relatively small particularly its small sized screen due to the popularity of mounting a large screen LCD (liquid crystal display) on the notebook computer. Hence, many people may buy notebook computers rather than desktop computers as their first choice in considering the advantages (e.g., compactness, portability, etc.) of notebook computer. Thus, more advanced, powerful notebook computers are commercially available in a faster pace due to its increasing popularity.

A notebook computer, as self-explanatory, means the computer can be easily opened or closed just like opening or closing a notebook. Hence, notebook computers are advantageous for its portability. A notebook computer comprises a display, a computer case, and at least one hinge interconnected the display and the computer case. In a nonoperating position the display is rested on the computer case. For using the notebook computer, a user can pivot the hinge to position the computer case at an optimum angle with respect to the computer case. Thereafter, the user can input data into the computer by keying a keyboard disposed on the computer case. Also, information is sent to the display via a data cable prior to showing on the screen of the display.

Conventionally, there are a plurality of electronic devices (e.g., CD-ROM drive, hard disk, floppy disk, power supply, one or more batteries, and/or modem card) are mounted in the case of a notebook computer. Hence, mounting of an additional one or more electronic devices in the computer case will have a great difficulty since the interior space of the computer case is very narrow. But portability can be compromised and it may detract from its external appearance if such electronic device(s) is(are) externally coupled to the computer case. In a case of replacing the motherboard with an advanced one for upgrading purpose, a user or technician may also experience great difficulty in detaching the motherboard from all attached electronic devices in a time consuming process since, as stated above, the interior space of the computer case is very narrow.

As stated above, an all-in-one notebook computer is constantly being sought by many computer manufacturers. Further, it is understood that only all-in-one notebook computers can survive in the competitive information product market. Thus, if a notebook computer manufacturer desires to win over other competitive manufacturers in the competitive information product market how to provide users with ergonomic, powerful, highly expandable, and all-in-one notebook computers in a reasonable price will be a deciding factor. Moreover, it is very beneficial to vast consumers.

### SUMMARY OF THE INVENTI/ON

A primary object of the present invention is to provide a structure of notebook computer incorporating an LCD due to its slimness and compactness and a motherboard disposed in the LCD, thereby reserving more interior space of the computer case for installing other electronic devices, reducing thickness of the computer case, and making the computer case more expandable. Further, it is possible of directly removing the computer case from the LCD for replacement. By utilizing the present invention, the above drawbacks of the prior art can be overcome. These drawbacks are that the interior space of the computer case is very narrow and thus its expansibility is poor due to the installation of the bulky motherboard in the computer case, and the process of detaching the motherboard from the computer case for replacement is very difficult.

The above and other objects, features and advantages of the present invention will become apparent from the following detailed description taken with the accompanying drawings.

### BRIEF DESCRIPTI/ON OF THE DRAWINGS

FIG. 1 is a block diagram of a preferred embodiment of the structure of a notebook computer according to the invention; and

FIG. 2 is a perspective view of the notebook computer for illustrating the location of vent openings.

### DETAILED DESCRIPTI/ON OF THE PREFERRED EMBODIMENTS

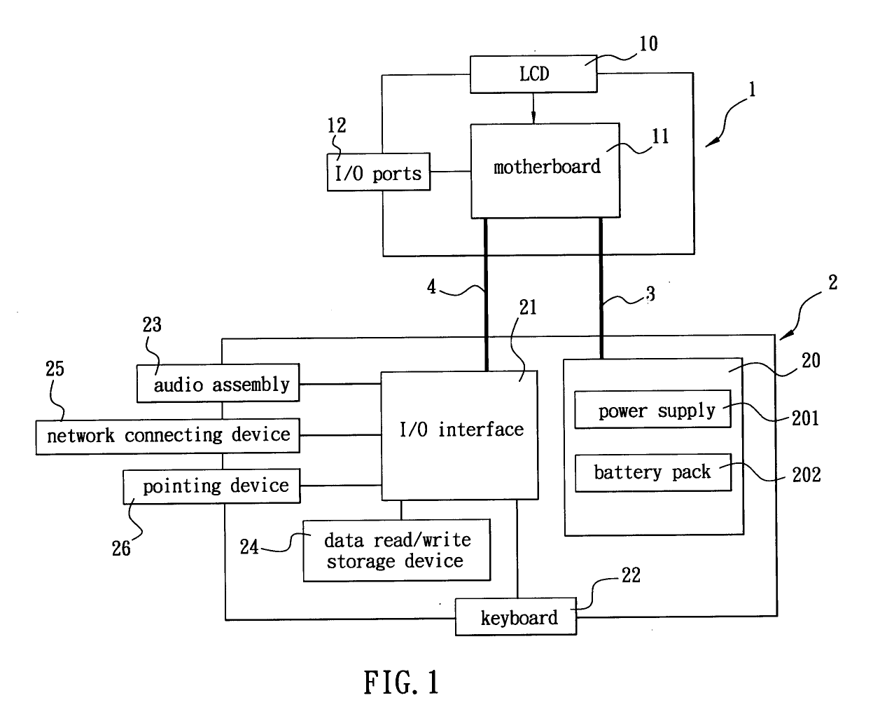

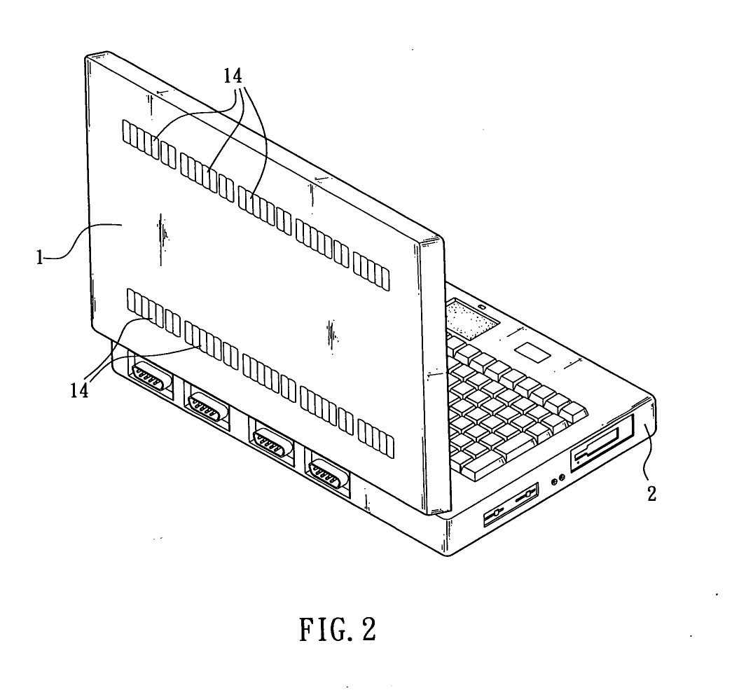

Referring to FIGS. 1 and 2, there is shown the structure of a notebook computer in accordance with the invention comprising a display assembly 1 including a LCD 10 fitted on its front surface, and a motherboard 11 inside the display assembly 1, the motherboard 11 being coupled to the LCD 10; and a computer case 2 comprising a power supply assembly 20 and at least one input/output (I/O) interface (e.g., SCSI (Small Computer System Interface) or IDE (Integrated Drive Electronics)) 21. The power supply assembly 20 is electrically coupled to the motherboard 11 by means of a power cord 3. The power supply assembly 20 is adapted to supply a rated power to the motherboard 11. The I/O interface 21 is coupled to the motherboard 11 by means of a data cable 4 so that data can be communicated between the I/O interface 21 and the motherboard 11.

Referring to FIGS. 1 and 2 again, a pair of a plurality of vent openings 14 are disposed in parallel on the back of the display assembly 1 (i.e., on the back of the LCD 10). The vent openings 14 are adapted to dissipate heat generated by various components (e.g., CPU (central processing unit), etc.) in the motherboard 11 to the outside.

Referring to FIGS. 1 and 2 again, in the invention the power supply assembly 20 is implemented as a power supply 201, a battery pack 202, or a combination thereof as shown. The battery pack 202 is implemented as a Ni—Cd battery, Ni-MH battery, Lithium ion battery, or Lithium polymer battery.

Referring to FIG. 1 again, in the invention an audio assembly 23 is provided in the computer case 2. The audio assembly 23 is coupled to the I/O interface 21. The audio assembly 23 comprises at least one speaker, a microphone, and a sound card.

Referring to FIGS. 1 and 2 again, in the invention a keyboard 22 is provided on the front surface of the motherboard 2. The keyboard 22 is coupled to the I/O interface 21. As such, a user can input data into the motherboard 11 by keying the keyboard 22. Also, the input data is shown on the LCD 10.

Referring to FIGS. 1 and 2 again, in the invention on the surface of the computer case 2 there is further provided a plurality of I/O ports 12 including parallel port and serial port coupled to the motherboard 11. The I/O ports 12 can also be implemented as I/O ports 12 of external bus complying with IEEE (Institute of Electronics Engineers)1394). One of the I/O ports 12 can also be a TV-OUT so that picture shown on the LCD 10 can be displayed on a TV. Alternatively, the other one of the I/O ports 12 can be a CRT (cathode ray tube) port so that an external display can be coupled to the invention for supporting a dual screen display in the same time. Moreover, the still other one of the I/O ports 12 can be an IrDA port (Infrared Data Association Port) so that a device having an infrared transmission capability (e.g., printer, PDA (Personal Digital Assistant), or cellular phone) or a bluetooth wireless network transmission device having a bluetooth transmission capability can be coupled to the invention.

Referring to FIGS. 1 and 2 again, at least one data read/write storage device 24 for reading/writing data is provided in the computer case 2. The data read/write storage device 24 is implemented as a floppy disk driver or hard disk.

Referring to FIGS. 1 and 2 again, in the invention a network connecting device 25 is provided in the computer case 2 for connecting the notebook computer to a local area network or the Internet. The network connecting device 25 is implemented as a NIC (Network Interface Card) or modern card.

Referring to FIGS. 1 and 2 again, in the invention a pointing device 26 is provided for coupling to the motherboard 11. The pointing device 26 is adapted to control a pointer shown on the LCD 10 if a window based operating system (e.g., MS Windows) is installed in the notebook computer. The pointing device 26 is implemented as a pointing stick (or called track point), touch pad, or trackball.

While the invention has been described by means of specific embodiments, numerous modifications and variations could be made thereto by those skilled in the art without departing from the scope and spirit of the invention set forth in the claims.

1. A notebook computer, comprising:
a display assembly comprising a LCD (liquid crystal display) fitted on its front surface, and an internal motherboard coupled to the LCD; and
a computer case comprising a power supply assembly and an input/output (I/O) interface,
wherein the power supply assembly is electrically coupled to the motherboard by means of a power cord for supplying a rated power to the motherboard, and the I/O interface is coupled to the motherboard by means of a data cable so that data can be communicated between the 1/O interface and the motherboard.

2. The notebook computer of claim 1, further comprising a plurality of vent openings on the display assembly for dissipating heat.

3. The notebook computer of claim 1, wherein the power supply assembly is a power supply.

4. The notebook computer of claim 1, wherein the power supply assembly is a battery pack.

5. The notebook computer of claim 1, further comprising an audio assembly in the computer case, the audio assembly being coupled to the I/O interface.

6. The notebook computer of claim 1, further comprising a keyboard on a surface of the motherboard, the keyboard being coupled to the I/O interface.

7. The notebook computer of claim 1, further comprising a plurality of I/O ports on a surface of the computer case, the I/O ports being coupled to the motherboard.

8. The notebook computer of claim 1, further comprising at least one data read/write storage device in the computer case, the data read/write storage device being coupled to the I/O interface.

9. The notebook computer of claim 1, further comprising a network connecting device in the computer case, the network connecting device being coupled to the I/O interface.

10. The notebook computer of claim 1, further comprising a pointing device on the surface of the computer case, the pointing device being coupled to the I/O interface.
